(19) United States
(12) Patent Application Publication
(10) Pub. No.: US 2009/0313110 A1
(43) Pub. Date: Dec. 17, 2009

(54) METHOD AND SYSTEM FOR SUPPORTING SELECTION OF REWARD PROGRAM

(75) Inventors: Takeshi ASAI, Osaka (JP); Kenichi Yamaguchi, Osaka (JP); Norihide Fujikawa, Osaka (JP)

Correspondence Address: STAAS & HALSEY LLP, SUITE 700, 1201 NEW YORK AVENUE, N.W., WASHINGTON, DC, 20005, US

(73) Assignee: FUJISTU LIMITED, Kawasaki (JP)

(21) Appl. No.: 12/548,860

(22) Filed: Aug. 27, 2009

Related U.S. Application Data
(63) Continuation of application No. PCT/JP2007/000254, filed on Mar. 19, 2007.

(51) Int. Cl. G06Q 30/00

(52) U.S. Cl. 705/14.32; 705/14.33

(57) ABSTRACT

A method for supporting a member in selecting one of reward programs includes providing a database storing item information that indicates, for each item, a name, and a reward program awarding a reward point, presenting the item information to the member, storing, in a multiple-service card, for each member, selected item information indicating items selected by the member by giving priorities thereto, obtaining, when a member is awarded a reward point in a shop, the selected item information of the member from the multiple-service card, determining that, among reward programs that award a reward point redeemable for any of the items indicated in the selected item information and are available in the shop, one of the reward programs awarding a reward point necessary to obtain an item placed in a highest priority is suitable for the member, and presenting the reward program thus determined to the member.

### CROSS-REFERENCE TO RELATED APPLICATIONS

This application is a continuing application, filed under 35 U.S.C. §111(a), of International Application PCT/JP2007/000254, filed on Mar. 19, 2007, the entire contents of which are incorporated herein by reference.

### FIELD

The embodiments discussed herein are related to a method and a system for supporting a reward program that awards members reward points redeemable for articles and services.

### BACKGROUND

Businesses that offer a reward program to customers who purchase merchandise or receive services have recently increased. The reward program is designed to issue reward points to customers in accordance with the amount of purchase, the frequency of purchase, or the like, and to allow the customers to redeem (exchange) reward points accumulated by the individual customers for articles, services, and the like. Such a reward program is sometimes called, for example, a “frequent flyer program”.

A business offers a unique reward program, while a plurality of businesses make a group to offer a common reward program. A credit card business, namely, a credit company also offers a reward program in which reward points are awarded (allocated) to a customer who has paid by a credit card issued by the credit company.

In some cases, reward points earned by a customer are centrally managed by a server or the like together with reward points earned by other customers. In other cases, reward points earned by a customer are stored and managed on a card of the customer.

In return for reward points accumulated by customers, businesses offer the customers a variety of articles such as accessories, commodities, foods, books or clothing. The businesses also offer the customers articles other than those mentioned above, e.g., vouchers, gift certificates, or tickets. Further, services such as trips, meals or accommodations are sometimes offered to the customers as items.

Thus, a customer can obtain a variety of articles and services in return for reward points accumulated by the customer. Further, participating in a plurality of reward programs enables a customer to select an article or a service from among the increased number of articles and services.

A method for improving the convenience of a user participating in a plurality of reward programs is disclosed in Japanese Laid-open Patent Publication No. 2002-099966. According to the method, in a reward points banking system including a storage means for storing reward points redeemable for optional merchandise for each user's account and a cashier means for managing the incoming and outgoing of the reward points stored in the storage means, the cashier means accepts a plurality of kinds of reward points and causes the storage means to store the reward points thus accepted. Further, the cashier means accepts reward points that have different values, calculates the reward points in such a manner that the reward points have a predetermined value per unit, and causes the storage means to store the calculated reward points.

Incidentally, upon payment of a purchase price, a customer can sometimes select which reward program is used to earn reward points corresponding to the payment from among a plurality of reward programs. For example, if a customer makes a purchase at a shop in a department store, the customer may select a reward program uniquely offered by the shop, or, alternatively, a reward program offered by the department store. If the customer pays by a credit card, the customer may also select a reward program offered by a credit company from which the credit card is issued.

As described above, a customer who can use a plurality of reward programs can select articles and services for which reward points accumulated thus far are redeemed from among a variety of articles and services.

As a customer has more choices of reward programs, however, the customer is confused with which reward program is to be selected for earning reward points to obtain an article or a service desired by the customer.

### SUMMARY

According to an aspect of the invention, a method is provided for supporting a member in selecting any one of a plurality of reward programs that award the member a reward point and allow the member to redeem reward points accumulated by the member for an item. The method includes providing an item information storage section that stores item information, the item information indicating, on an item-by-item basis, a name of the item, a quantity of reward points required to be redeemed for the item, and a reward program awarding a reward point redeemable for the item, presenting the item information to the member, storing, in a selected item information storage section, on a member-by-member basis, selected item information indicating items selected by the member by giving priorities to the items thus selected, obtaining, when a member is awarded a reward point in a shop, the selected item information of the member from the selected item information storage section, determining that, among a plurality of reward programs that award a reward point redeemable for any of the items indicated in the selected item information thus obtained and are available in the shop, one of the plurality of reward programs is suitable for the member, said one of the plurality of reward programs awarding a reward point necessary to obtain an item placed in a highest priority order indicated in the selected item information, and presenting, to the member, said one of the plurality of reward programs thus determined.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the hardware configuration of a terminal;

FIG. 2 is a diagram illustrating an example of the functional configuration of a terminal;

FIG. 3 is a diagram illustrating an example of how a terminal is connected to other devices;

FIG. 4 is a diagram illustrating an example of information stored on a multiple-service card;

FIG. 5 is a diagram illustrating an example of the appearance of an items setting device;

FIG. 6 is a diagram illustrating an example of the functional configuration of an items setting device;

FIG. 7 is a diagram illustrating an example of an items database;

FIG. 8 is a diagram illustrating an example of an items acquisition target setting screen;

FIGS. 9A and 9B are diagrams illustrating an example of a reward points allocation rule table and an example of an exchange ratio table, respectively;

FIG. 10 is a diagram illustrating an example of a privilege table;

FIG. 11 is a flowchart illustrating an example of the flow of an appropriate reward program determination process;

FIG. 12 is a diagram illustrating an example of a reward program information screen;

FIG. 13 is a flowchart illustrating an example of the overall processing flow of a terminal;

FIG. 14 is a diagram illustrating an example of a receipt;

FIG. 15 is a flowchart illustrating a modification of the flow of an appropriate reward program determination process; and

FIG. 16 is a diagram illustrating an example of a receipt.

### DESCRIPTION OF EMBODIMENT(S)

Preferred embodiments of the present invention will be explained with reference to accompanying drawings.

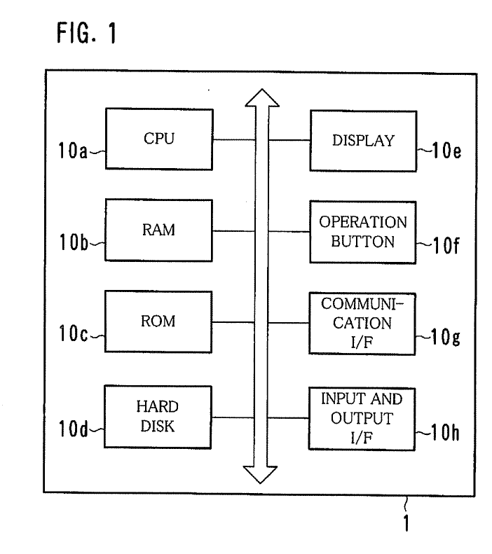

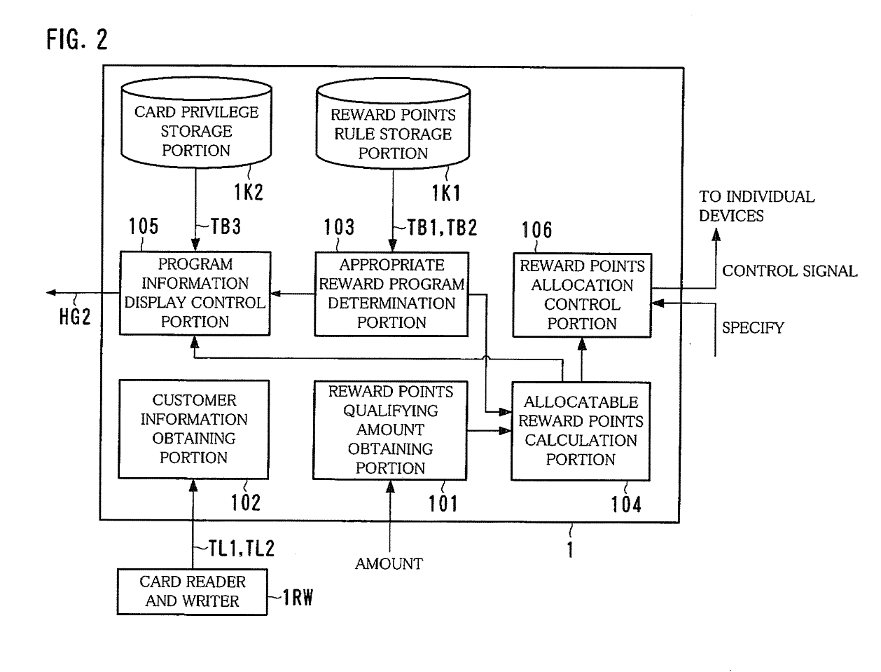

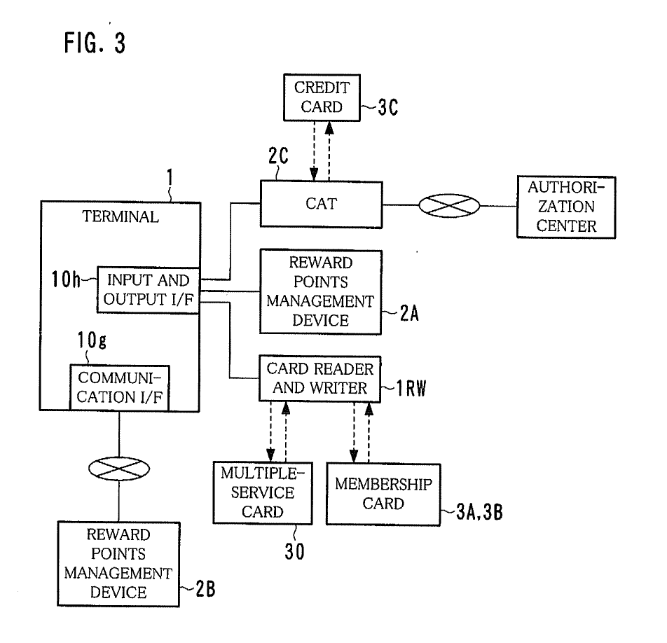

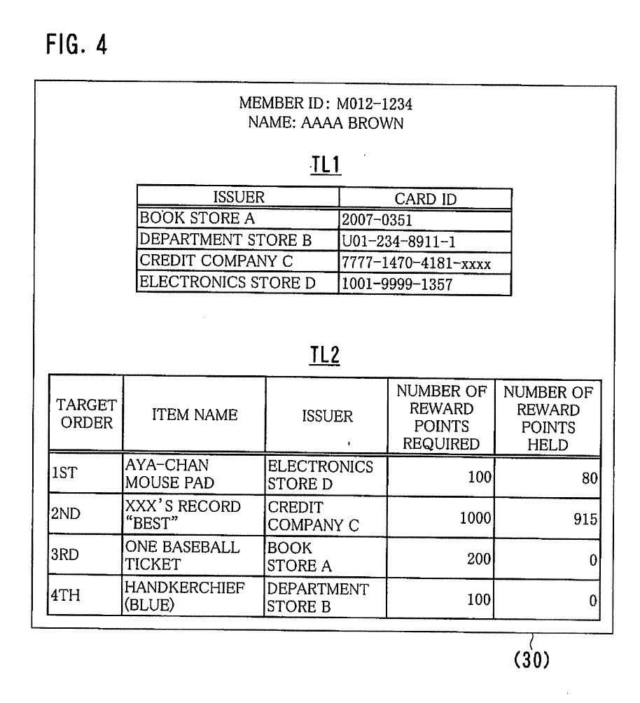

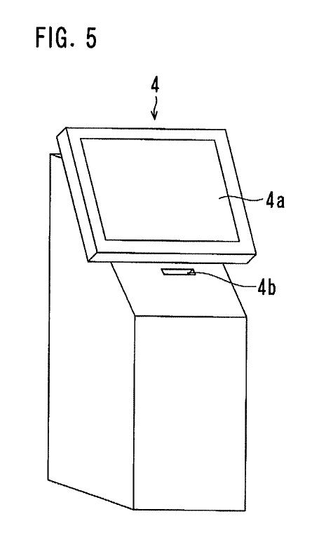

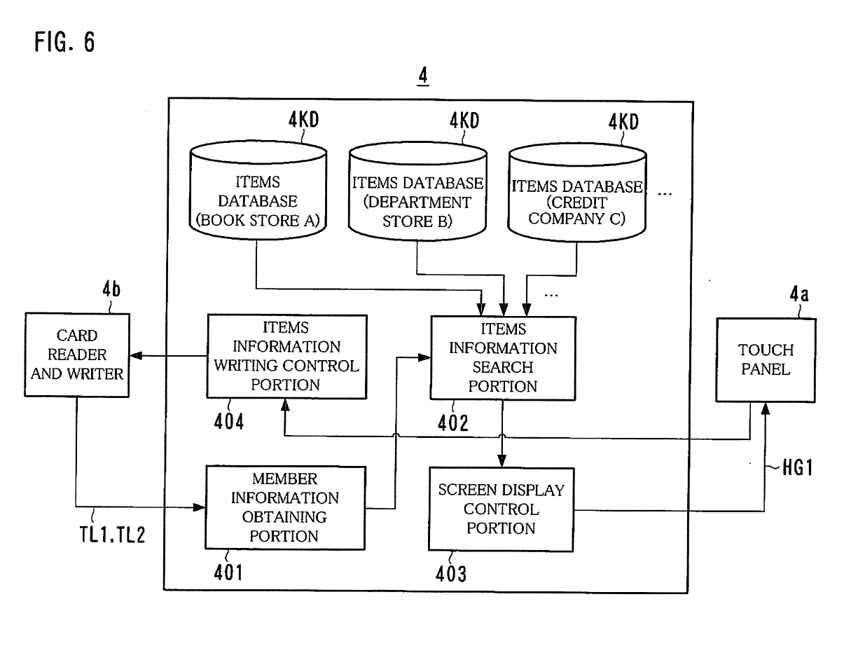

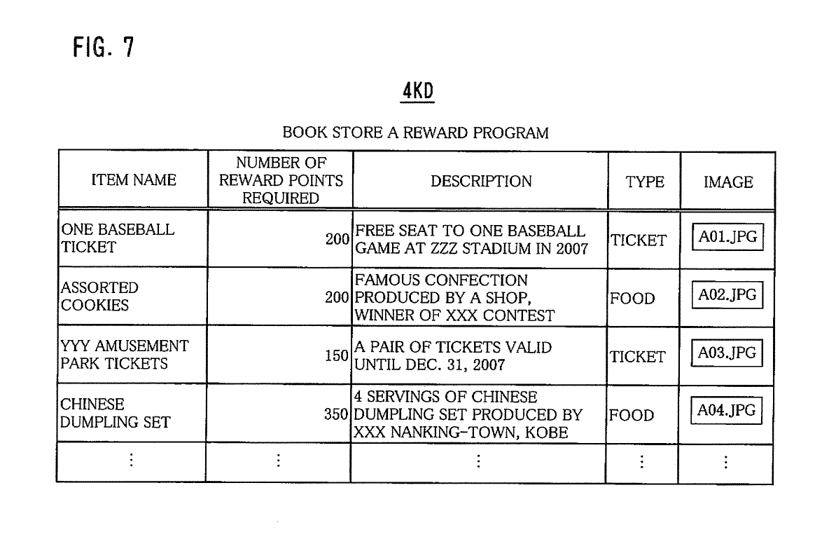

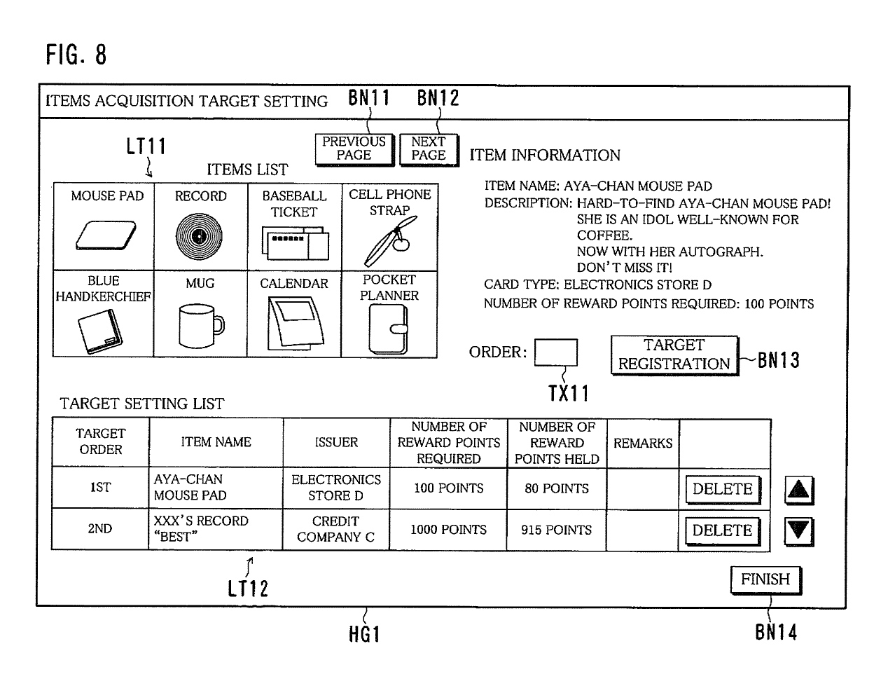

FIG. 1 is a diagram illustrating an example of the hardware configuration of a terminal 1; FIG. 2 is a diagram illustrating an example of the functional configuration of the terminal 1; FIG. 3 is a diagram illustrating an example of how the terminal 1 is connected to other devices; FIG. 4 is a diagram illustrating an example of information stored on a multiple-service card 30; FIG. 5 is a diagram illustrating an example of the appearance of an items setting device 4; FIG. 6 is a diagram illustrating an example of the functional configuration of the items setting device 4; FIG. 7 is a diagram illustrating an example of an items database 4 KD; and FIG. 8 is a diagram illustrating an example of an items acquisition target setting screen HG1.

The terminal 1 according to an embodiment of the invention is a point-of-sale (POS) terminal used in a shop that sells merchandise or provides services. A POS cash register, a personal computer, or the like is used as the terminal 1.

Referring to FIG. 1, the terminal 1 is configured of a Central Processing Unit (CPU) 10a, a Random Access Memory (RAM) 10b, a Read Only Memory (ROM) 10c, a hard disk 10d, a display 10e, an operation button 10f, a communication interface 10g, an input and output interface 10h, and the like.

The communication interface 10g is an interface to connect to a host of a POS system or a reward points management device managing reward points of a reward program, which is sometimes called a “frequent flyer program”. A Network Interface Card (NIC), a modem, or the like is used as the communication interface 10g.

The input and output interface 10h is an interface to connect to, for example, a Credit Authorization Terminal (CAT) for connecting to an authorization center of a credit card company or a credit company, the reward points management device, or a card reader and writer. The input and output interface 10h is, for example, a USB interface, IEEE1394 interface, or RS-232C interface.

The operation button 10f is used for a clerk to enter the amount of a product purchased by a customer, a product code thereof, and the like. In the case where a barcode reader is connected to the terminal 1, the clerk may use the barcode reader instead of the operation button 10f to enter the amount of the product, the product code thereof, and the like. As discussed later, the operation button 10f is also used to select a card in which the customer desires to accumulate reward points.

The display 10e serves to display, for example, a reward program information screen HG2 as described later.

Software for performing a process such as a sales management process or an inventory management process in cooperation with the host of the POS system is installed in the ROM 10c or the hard disk 10d as with conventional technologies.

The ROM 10c or the hard disk 10d stores programs and data for implementing, as illustrated in FIG. 2, functions of a reward points qualifying amount obtaining portion 101, a customer information obtaining portion 102, an appropriate reward program determination portion 103, an allocatable reward points calculation portion 104, a program information display control portion 105, a reward points allocation control portion 106, a reward points rule storage portion 1K1, a card privilege storage portion 1K2, and so on. These programs and data are loaded into the RAM 10b as necessary, whereupon the programs are executed by the CPU 10a.

The terminal 1 is connected to different devices via the communication interface 10g and the input and output interface 10h depending on reward programs that are offered in a shop using the terminal 1.

The following is a description of the terminal 1, taking an example of a terminal 1A that is used in a book store A offering the following reward programs (1)-(3), and is connected to other devices as illustrated in FIG. 3.

(1) Book store A reward program: This program is a reward program offered by the book store A issuing reward points independently. Reward points issued to a customer are centrally managed by a reward points management device 2A connected to the terminal 1A via the input and output interface 10h. A member participating in this program is given a membership card 3A storing thereon a card ID for distinguishing the member from other members.

(2) Department store B reward program: This program is a reward program offered by a department store B where the book store A is located and which issues reward points. Reward points issued to a customer are centrally managed by a reward points management device 2B installed in a management division of the department store B. The terminal 1A is connectable to the reward points management device 2B through the communication interface 10g. A member participating in this program is given a membership card 3B storing thereon a card ID for distinguishing the member from other members.

(3) Credit company C reward program: This program is a reward program offered by a credit company C with which the book store A is affiliated. The terminal 1A is connected to a Credit Authorization Terminal (CAT) 2C of the credit company C via the input and output interface 10h. The CAT 2C is connectable to an authorization center of the credit company C via, for example, a public line or a dedicated line. Only a person possessing a credit card 3C issued by the credit company C can participate in this program.

Further, a card reader and writer 1RW for reading data from the multiple-service card 30, which is described later, or writing data into the multiple-service card 30 is connected to the input and output interface 10h.

A customer who has purchased a product at the book store A can earn (can be given) reward points depending on the amount of the purchase from any one of issuers of the book store A, the department store B, and the credit company C. At this time, the customer determines, as before, an issuer from which the reward points are issued, and presents a card corresponding to the issuer to a clerk.

If the customer participates in a multiple-service card program, the customer may present a card for the multiple-service card program to the clerk. The “multiple-service card program” is designed to use a single card into which information of cards issued by a plurality of issuers is integrated. A plurality of shops may make a group to operate such a multiple-service card program. Alternatively, an Internet Service Provider (ISP) or the like may operate such a multiple-service card program.

Hereinafter, a card into which information of cards issued by a plurality of issuers is integrated is referred to as a “multiple-service card 30”.

The multiple-service card 30 may be, for example, an IC card including an IC chip therein or a magnetic card including a magnetic stripe thereon. Alternatively, the multiple-service card 30 may be a mobile phone terminal containing an IC chip therein.

As illustrated in FIG. 4, the multiple-service card 30 stores thereon, for example, information on a member ID, a name, and the like of a member of the multiple-service card program, a card list table TL1, and a target items list table TL2.

The card list table TL1 indicates a list of issuers and card identification numbers (card IDs) of cards possessed by the member, such as a credit card or a membership card for a reward program.

The target items list table TL2 indicates a list of names of items (items names) for which the member desires to redeem reward points accumulated by the member, issuers of reward points redeemable for the desired items, the individual numbers of reward points required to be redeemed for the desired items (the required number of reward points), and the individual numbers of reward points issued by the issuers and currently owned by the member (the number of reward points held). Information about the individual items is listed in the order in which they are targeted (desired). Hereinafter, the order of items to be targeted is referred to as a “target order”.

When an operator of a multiple-service card program performs the procedure for enrollment of a prospective member who wishes to participate in the multiple-service card program, he/she conveys, to the operator, information such as his/her name, issuers and card IDs of cards possessed thereby, and items to be selected as targets.

He/She may register to participate in the multiple-service card program by submitting a predetermined application paper to the operator of the multiple-service card program. Alternatively, he/she may register to participate in the multiple-service card program online by submitting a Web page application form that is prepared by the operator on a Web server on the Internet.

The operator prepares, based on the details of the information conveyed by him/her, a multiple-service card 30 storing thereon the information described earlier with reference to FIG. 4, and passes the multiple-service card 30 to him/her. In the case where he/she uses a mobile phone terminal as a multiple-service card 30, the Web server or the like may automatically deliver the information described earlier with reference to FIG. 4 to the mobile phone terminal to allow the mobile phone terminal to store the information on an IC chip thereof.

Reward programs of individual companies provide a wide variety of articles and services. Such articles and services are collectively referred to as “items” herein. Accordingly, at a time when the prospective member applies for participating in the multiple-service card program, he/she sometimes cannot decide which articles and services are to be selected as target items. Further, after participating in the multiple-service card program, the member sometimes desires to change articles and services that had been selected as target items because his/her preference has changed or he/she has already received articles and services.

In view of this, each shop may install the items setting device 4 as illustrated in FIG. 5. The items setting device 4 has a size similar to that of a Cash Dispenser (CD) or an Automatic Teller Machine (ATM), and includes a touch panel 4a and a card reader and writer 4b.

In addition, as illustrated in FIG. 6, the items setting device 4 also includes a member information obtaining portion 401, an items information search portion 402, a screen display control portion 403, an items information writing control portion 404, and items databases 4 KD.

The items database 4 KD is provided for each reward program, and stores information on articles and services provided in return for reward points issued through the corresponding reward program. As illustrated in FIG. 7, for example, the items database 4 KD for the book store A reward program stores, for each article or service for which reward points of the book store A reward program can be redeemed, the following information: the name of such an article or a service, the number of reward points required to be redeemed for the article or service (the required number of reward points), description of the article or service to the member, the type of the article or service, an image of the article or service, and the like. The information of such an image is, for example, a JPEG image file obtained by taking an image of the actual item or a sample of the item by a digital camera, or the like.

The member information obtaining portion 401 controls the card reader and writer 4b to read and obtain the card list table TL1 and the target items list table TL2 from a multiple-service card 30 of a member who intends to set target articles and services.

The items information search portion 402 searches for information of articles and services in the items databases 4 KD in accordance with the details of the card list table TL1 read from the multiple-service card 30 or the details of operation on the touch panel 4a.

The screen display control portion 403 generates a screen in accordance with, for example, the result of the search conducted by the items information search portion 402, the details of the operation on the touch panel 4a, or the details of the target items list table TL2 read from the multiple-service card 30, and causes the touch panel 4a to display such a screen.

The items information writing control portion 404 controls the card reader and writer 4b to write the target items list table TL2 indicating a list of articles and services set by the member into the multiple-service card 30.

The following is a description of an example of steps of processes of the member information obtaining portion 401, the items information search portion 402, the screen display control portion 403, and the items information writing control portion 404. A member inserts a multiple-service card 30 of the member into the card reader and writer 4b, and presses a predetermined button.

In response to this, the member information obtaining portion 401 obtains the card list table TL1 and the target items list table TL2 stored on the multiple-service card 30.

The items information search portion 402 searches, in the individual items databases 4 KD, for information on articles and services provided by issuers of cards indicated in the card list table TL1. As illustrated in FIG. 4, for example, in the case where the card list table TL1 indicates the book store A, the department store B, the credit company C, and an electronics store D as issuers offering the reward programs, the items information search portion 402 calls information on articles and services from the individual items databases 4 KD of the four issuers.

The screen display control portion 403 causes the touch panel 4a to display the items acquisition target setting screen HG1, as illustrated in FIG. 8, based on the information on the articles and services obtained as a result of the search conducted by the items information search portion 402. The items acquisition target setting screen HG1 includes an items list LT11 and a target setting list LT12.

The items list LT11 is a list of the articles and services obtained as a result of the search conducted by the items information search portion 402. Note that, in some cases, not all the articles and services can be displayed at one time due to the size of the screen. In such cases, the screen display control portion 403 arranges images of the articles and services in such a manner that they are allocated to a plurality of pages. Then, each time a previous page button BN11 or a next page button BN12 is pressed, the screen display control portion 403 arranges again images of the articles and services corresponding to the previous page or the next page accordingly.

The target setting list LT12 is a list of information on target items of the member arranged in the target order. Initially, the screen display control portion 403 arranges, in the target setting list LT12, information on articles and services indicated in the target items list table TL2 obtained by the member information obtaining portion 401 in the target order. If nothing is indicated in the target items list table TL2, all the lines of the target setting list LT12 are left blank.

A member touches a part of the items list LT11 corresponding to an article or a service to be selected as a target. In response to this, the screen display control portion 403 arranges information on the item name of the item thus selected, description thereof, and the required number of reward points therefor, for example, on the right side of the items list LT11.

After determining the target item, the member touches the image of the target item thereby to select the target item, and subsequently specifies the target order of the target item in a text box TX11 to press a target registration button BN13.

In response to this, the screen display control portion 403 causes the touch panel 4a to display information on the target item in a line corresponding to the target order specified in the text box TX11 among lines of the target setting list LT12. If the line is already filled with information on a target item that was previously set, then the screen display control portion 403 deletes the information on the previously-set target item, so that the previous information is overwritten with the information on the target item specified this time.

The member performs the operation described above, and thereby newly specifies or respecifies target items including the first target item through an optional order of target item. After newly specifying or respecifying the target items, the member presses a finish button BN14.

In response to this, the items information writing control portion 404 controls the card reader and writer 4b in such a manner that the information on the item name of each of the target items specified as described above, an issuer (issuer of reward points redeemable for the item), the required number of reward points, and the number of reward points held is written into or updated in a record (line) corresponding to the target order of each of the target items among records (lines) of the target items list table TL2 stored in the multiple-service card 30.

Then, the member removes the multiple-service card 30 from the card reader and writer 4b. If the member desires to change again the target items, then the member performs again the operation described above.

The number of reward points held, which is indicated in the target items list table TL2 on the items acquisition target setting screen HG1, is known by making an inquiry to the system for managing reward points of each of the reward programs, namely, to the reward points management device 2A, the reward points management device 2B, or an authorization center. The same applies to the description given below.

The existing CD or ATM, or a device to award (allocate) reward points specially to a customer who has visited a shop where such a device is installed, i.e., a visiting reward points register, may be used as the items setting device 4.

Another configuration is possible in which a member performs settings of target items by using a personal computer or a mobile phone terminal of the member via the Internet or the like. Further, it is also possible to perform setting of the details of the card list table TL1 by using the items setting device 4, a personal computer, or a mobile phone terminal.

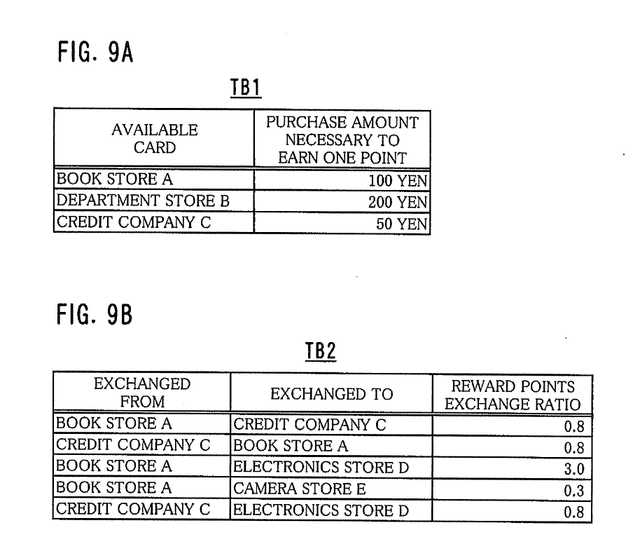

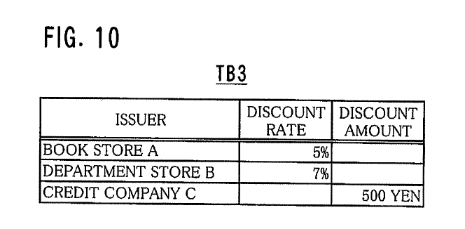

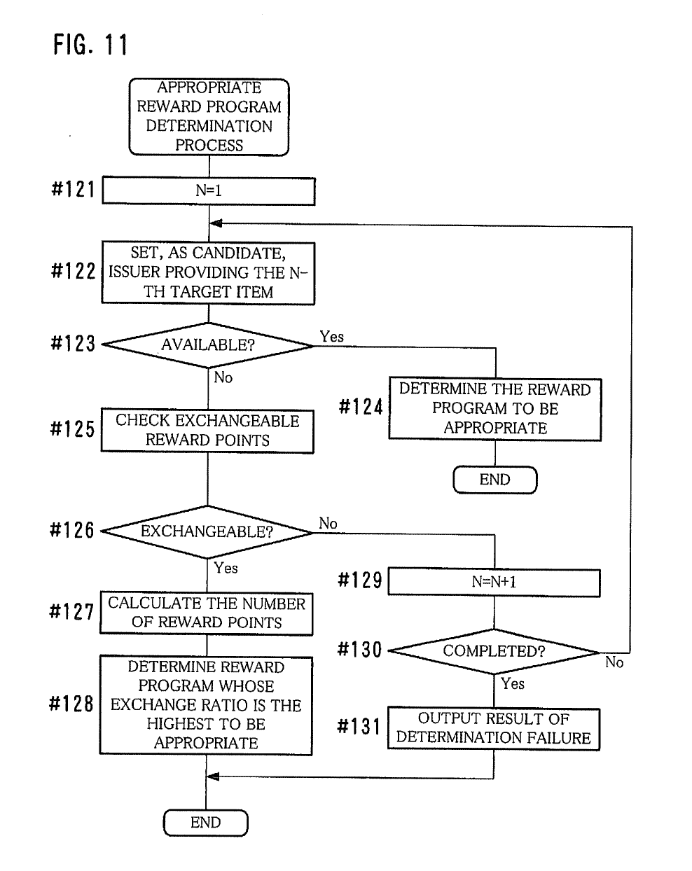

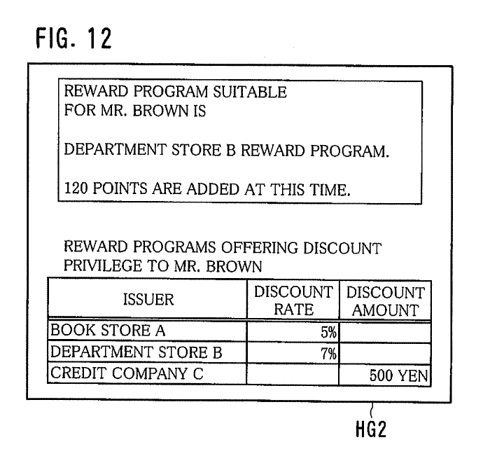

FIGS. 9A and 9B are diagrams illustrating an example of a reward points allocation rule table TB1 and an example of an exchange ratio table TB2, respectively; FIG. 10 is a diagram illustrating an example of a privilege table TB3; FIG. 11 is a flowchart illustrating an example of the flow of an appropriate reward program determination process; and FIG. 12 is a diagram illustrating an example of the reward program information screen HG2.

The following is a detailed description of, for example, how the process is performed by the individual portions of the terminal 1 illustrated in FIG. 2.

The point rule storage portion 1K1 stores information about rules of reward programs that are offered by a shop where the terminal 1 is used, as discussed below.

To be specific, the point rule storage portion 1K1 stores the reward points allocation rule table TB1 indicating how much money should be spent on purchase in order for a customer to earn one reward point for each reward program offered by the shop. As illustrated in FIG. 9A, for example, the reward points allocation rule table TB1 of the terminal 1 of the book store A, i.e., of the terminal 1A indicates, for the individual reward programs offered by the book store A, the department store B, and the credit company C, how much money should be spent on purchase in order for a customer to earn one reward point.

Further, the point rule storage portion 1K1 stores the exchange ratio table TB2 indicating an exchange ratio used when reward points of a certain reward program are exchanged for reward points of a different reward program. For example, the exchange ratio table TB2 of the terminal 1A indicates exchange ratios as illustrated in FIG. 9B.

Referring back to FIG. 2, the card privilege storage portion 1K2 stores information about privileges of reward programs available in a shop where the terminal 1 including the card privilege storage portion 1K2 is used. As illustrated in FIG. 10, the card privilege storage portion 1K2 of the terminal 1A stores the privilege table TB3. The privilege table TB3 indicates a discount rate specially applied to customers who have used the book store A reward program, a discount rate specially applied to customers who have used the department store B reward program, and a discount amount specially applied to customers who have used the credit company C reward program.

The reward points qualifying amount obtaining portion 101 through the reward points allocation control portion 106 perform a process for applying a multiple-service card program to a customer who has made a purchase and awarding (issuing) reward points to the customer.

The reward points qualifying amount obtaining portion 101 obtains information indicating the amount of money corresponding to which reward points are to be awarded. For example, when the customer pays for the purchase, the reward points qualifying amount obtaining portion 101 obtains information indicating the amount of the purchase entered by a clerk who operates the operation button 10f, a barcode reader, or the like.

The customer information obtaining portion 102 causes the card reader and writer 1RW to read the card list table TL1 and the target items list table TL2, both of which are illustrated in FIG. 4, stored on the multiple-service card 30 of the customer who makes a purchase, and thereby obtains the same.

The appropriate reward program determination portion 103 determines, based on the card list table TL1 and the target items list table TL2 obtained by the customer information obtaining portion 102, which reward program is appropriate to award reward points to the customer making a purchase. Such a determination is performed according to the steps illustrated in the flowchart of FIG. 11.

A reward program providing the first target item indicated in the target items list table TL2, i.e., a reward program by which the customer can earn reward points necessary to obtain the first target item, is set to be a candidate (#121 and #122 of FIG. 11). The reward program thus set is hereinafter referred to as a “candidate reward program”.

If the candidate reward program is available in the shop (Yes in #123), then the appropriate reward program determination portion 103 determines that it is appropriate to award the customer reward points of the candidate reward program (#124).

On the other hand, if the candidate reward program is not available in the shop (No in #123), then the appropriate reward program determination portion 103 checks, based on the exchange ratio table TB2 (see FIG. 9B), whether or not the shop can award the customer reward points of a different reward program which can be exchanged for reward points of the candidate reward program (#125). If such a different reward program is found (Yes in #126), then the appropriate reward program determination portion 103 determines that it is appropriate to award the customer reward points of such a different reward program (#128).

If a plurality of such different reward programs are found, then calculation (estimation) of the number of reward points is performed for the case where individual reward points of such different reward programs are temporarily awarded and the individual reward points are exchanged for reward points of the candidate reward program. Such calculation (estimation) is made based on the reward points allocation rule table TB1 and the exchange ratio table TB2 (#127). Then, the appropriate reward program determination portion 103 determines that one of such different reward programs whose exchange ratio for exchanging reward points thereof for reward points of the candidate reward program is the highest is an appropriate reward program (#128).

If the candidate reward program is not available in the shop, and at the same time, if there are no other reward programs whose reward points can be exchanged for reward points of the candidate reward program (No in #123 and No in #126), then a reward program providing an item corresponding to the next target order is set to be a candidate (#129, No in #130, and #122). Then, the appropriate reward program determination portion 103 determines an appropriate reward program by the method discussed above (#123 to #128).

In the case where no appropriate reward program is found even if the appropriate reward program determination portion 103 sets a reward program providing an item corresponding to the lowest target order to be a candidate, and performs the process of Step #123 to Step #128 (Yes in #130), then the appropriate reward program determination portion 103 outputs a result indicating that the determination fails (#131). In such a case, as before, the customer is prompted to determine which reward program is suitable for earning reward points corresponding to the purchase.

Referring back to FIG. 2, for the purchase this time, the allocatable reward points calculation portion 104 calculates the number of reward points, to be allocated to the customer, of the reward program that has been determined to be the appropriate reward program by the appropriate reward program determination portion 103. The calculation is made based on the amount of the purchase (purchase price) this time and the reward points allocation rule table TB1 (see FIG. 9A).

The program information display control portion 105 controls the display 10e to display the result of the determination made by the appropriate reward program determination portion 103 and the result of the calculation made by the allocatable reward points calculation portion 104.

Further, the program information display control portion 105 may control the display 10e to display, together with those results, privilege information such as a discount relating to a reward program of which reward points can be issued in the shop and in which the customer participates based on the card list table TL1 (see FIG. 4) and the privilege table TB3 (see FIG. 10). The program information display control portion 105 may control the display 10e to display, for example, the reward program information screen HG2 as illustrated in FIG. 12.

The clerk asks the customer whether or not it is acceptable to award the customer reward points of the reward program displayed on the display 10e, i.e., whether or not it is acceptable to add reward points to a card corresponding to the reward program thus displayed. Then, the clerk operates the operation button 10f, or the like to determine which reward program is used to award the customer the reward points this time in accordance with a reply from the customer and select the reward program thus determined.

The reward points allocation control portion 106 controls a device connected to the communication interface 10g or the input and output interface 10h in such a manner that the customer is given reward points of the reward program selected by the clerk by an amount of the reward points calculated by the allocatable reward points calculation portion 104. For example, if reward points of the book store A reward program are selected, then the reward points allocation control portion 106 controls the reward points management device 2A. In response to this, a device connected to the communication interface 10g or the input and output interface 10h, e.g., the reward points management device 2A allocates the reward points to the customer.

As a result of the process carried out by the reward points qualifying amount obtaining portion 101 through the reward points allocation control portion 106, the customer who has made a purchase is given reward points.

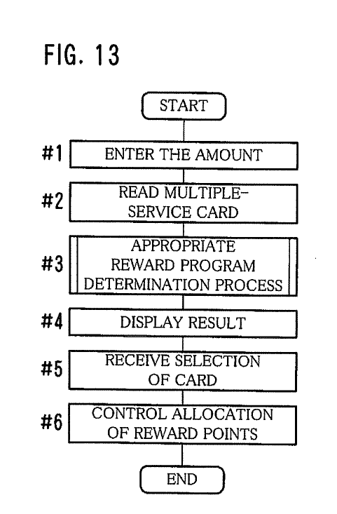

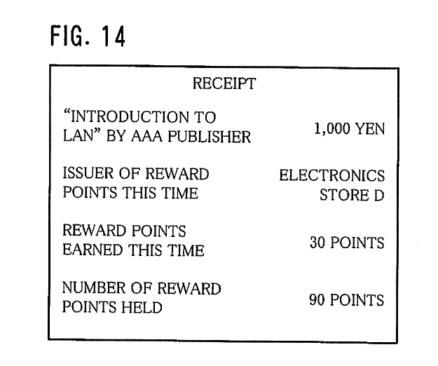

FIG. 13 is a flowchart illustrating an example of the overall processing flow of the terminal 1; and FIG. 14 is a diagram illustrating an example of a receipt.

The following is a description of the overall processing flow of the terminal 1 for the case where reward points are awarded, taking an example in which a customer X makes a purchase of 1,000 Yen at the book store A.

When the customer X purchases a product, a clerk of the book store A operates the operation button 10f to enter the amount of the product (product price), or causes a barcode reader to read a barcode on the product. Thereby, the product price is entered into the terminal 1 (#1).

Then, the customer X allows the clerk to take a multiple-service card 30 of the customer X and insert the multiple-service card 30 into the card reader and writer 1RW. The card reader and writer 1RW reads the card list table TL1, the target items list table TL2, and the like stored on the multiple-service card 30, and thereby the tables thus read are entered into the terminal 1 (#2).

The terminal 1 determines a reward program suitable for the customer X and calculates the number of reward points to be awarded to the customer X for the case where the reward program thus determined is selected according to the procedure described earlier with reference to FIG. 11 (#3).

For example, in the case where the individual details of the card list table TL1 and the target items list table TL2, both of which are obtained in Step #2, are the same as those illustrated in FIG. 4, the terminal 1 initially checks whether or not an electronics store D reward program is appropriate; however the electronics store D reward program is not available in the book store A. As illustrated in the exchange ratio table TB2 of FIG. 9B, however, the book store A can issue reward points that can be exchanged for reward points of the electronics store D reward program, i.e., reward points of each of the book store A reward program and the credit company C reward program.

For the purchase this time, based on the reward points allocation rule table TB1 and the exchange ratio table TB2, the terminal 1 temporarily issues reward points of the book store A reward program and calculates the number of reward points for a case in which the reward points of the book store A reward program are exchanged for reward points of the electronics store D reward program, and further, temporarily issues reward points of the credit company C reward program and calculates the number of reward points for a case in which the reward points of the credit company C reward program are exchanged for reward points of the electronics store D reward program. Then, the terminal 1 compares both the results of the calculation with each other, and selects, as an appropriate reward program, a reward program whose exchange ratio of the reward points for reward points of the electronics store D reward program is higher, from among the book store A reward program and the credit company C reward program.

To be specific, the product price is 1,000 yen at this time. If reward points of the book store A reward program are awarded, and are exchanged for reward points of the electronics store D reward program, then 30 reward points are obtained by the following formula: 1,000 (yen)/100 (yen per point)·3.0=30 (points). On the other hand, if reward points of the credit company C reward program are awarded, and are exchanged for reward points of the electronics store D reward program, then 16 reward points are obtained by the following formula: 1,000 (yen)/50 (yen per point)·0.8=16 (points). Thus, the terminal 1 determines that the book store A reward program is appropriate for the customer X.

Referring back to the flowchart of FIG. 13, the terminal 1 displays the result of the determination and the calculation (#4). At this time, as illustrated in FIG. 12, a discount privilege may be displayed along with the result of the determination and the calculation.

The clerk conveys the details thus displayed to the customer X, and asks the customer X which reward program is desired to earn the reward points this time, i.e., asks the customer X which reward program card is used to accumulate the reward points this time. Then, the clerk operates the terminal 1 to designate the reward program selected by the customer X.

Upon the receipt of the designation (#5), the terminal 1 controls a device corresponding to the reward program thus designated in such a manner that reward points of the designated reward program are awarded to the customer X (#6).

Note that application of the discount changes the purchase price. Accordingly, in such a case, the number of reward points calculated in Step #3 is sometimes different from the number of reward points corresponding to the changed purchase price. To cope with this, in the case where the discount is applied, it is possible to calculate again the number of reward points to be awarded before awarding the customer the reward points.

In the case where reward points of a reward program other than the candidate reward program are awarded, the reward points may automatically be exchanged for reward points of the candidate reward program.

As illustrated in FIG. 14, a receipt specifying a point service whose reward points are awarded this time and the number of reward points earned this time may be issued and passed to the customer.

This embodiment enables a customer who can use a plurality of reward programs to select which reward program is to be used to earn reward points more easily than is conventionally possible.

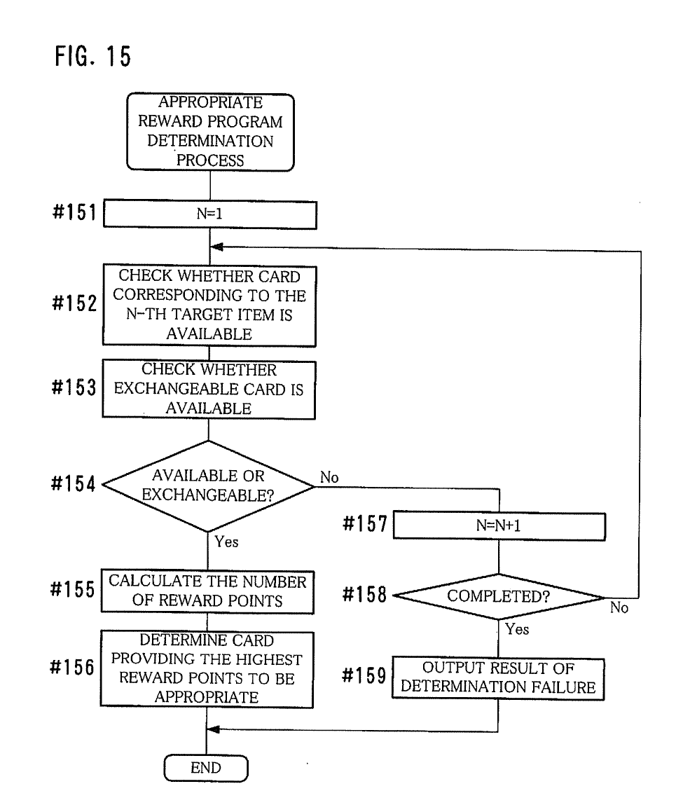

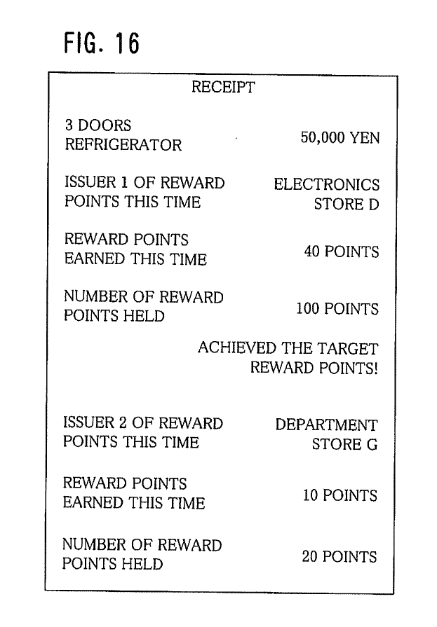

FIG. 15 a flowchart illustrating a modification of the flow of an appropriate reward program determination process; and FIG. 16 is a diagram illustrating an example of a receipt.

In this embodiment, the terminal 1 suggests a reward program appropriate for a customer who has made a purchase. Then, if the customer selects the reward program, the terminal 1 allocates reward points of the reward program to the customer. Stated differently, the terminal 1 inquires of the customer whether or not it is acceptable to allocate, to the customer, reward points of the reward program that has been determined to be an appropriate reward program. Instead, however, the terminal 1 may be configured to automatically allocate, to the customer, reward points of such a reward program without making such an inquiry to the customer.

If a customer does not need such an inquiry, the customer may perform setting of information to that effect on a multiple-service card 30 of the customer in advance. If the customer makes a payment at a shop, and such information is stored (set) on the multiple-service card 30 of the customer, then the terminal 1 immediately awards the customer reward points of the reward program that has been determined to be an appropriate reward program before the reward program information screen HG2 is displayed.

In this embodiment, the card list table TL1 and the target items list table TL2 of a customer are managed on a multiple-service card 30 of the customer. Stated differently, information on the tables is managed in a decentralized manner. Instead, however, the card list tables TL1 and the target items list tables TL2 of the individual customers may be managed by a server in a centralized manner on a customer-by-customer basis. In such a case, the terminal 1 may request the server to send the card list table TL1 and the target items list table TL2, and obtain the same, instead of causing the card reader and writer 1RW to read and obtain the same. Likewise, the items setting device 4 may obtain, from the server, the card list table TL1 and the target items list table TL2, and transmit, to the server, information about items specified by a customer (member) in order to reflect such information in the target items list table TL2.

In this embodiment, the terminal 1 suggests a reward program that has been determined to be an appropriate reward program by displaying the same on the display 10e. Instead, however, the terminal 1 may suggest such a reward program by outputting audio via a speaker.

In this embodiment, the case of a shop located in a department store is exemplified. This embodiment is also applicable to the case of a shop that sells merchandise or provides services on a Web site on the Internet, namely, to the case of an on-line shop.

In this embodiment, the appropriate reward program determination process is carried out according to the method described earlier with reference to FIG. 11. In some cases, however, reward points of a desired reward program required to obtain a target item of a customer may be awarded more in the case where reward points of another reward program are temporarily awarded and are converted into (exchanged for, or changed to) reward points of the desired reward program than in the case where reward points of the desired reward program are directly awarded. Accordingly, the appropriate reward program determination process may be carried out according to the method illustrated in FIG. 15.

Referring to FIG. 15, a reward program corresponding to an item set as the first target order which is indicated in the target items list table TL2 (see FIG. 4) is set to be a candidate (#151).

The appropriate reward program determination portion 103 checks whether or not the reward program thus set to be a candidate is available in a shop (#152). The appropriate reward program determination portion 103 further checks whether or not the shop can award the customer reward points of other reward programs that can be exchanged for reward points of the candidate reward program (#153).

If the candidate reward program is available in the shop, or, alternatively, the shop can award the customer reward points of other reward programs that can be exchanged for reward points of the candidate reward program (Yes in #154), then the appropriate reward program determination portion 103 calculates individual numbers of reward points as discussed below (#155).

The appropriate reward program determination portion 103 calculates the number of reward points of the candidate reward program in accordance with the amount of purchase this time. Hereinafter, the number of such reward points is referred to as a “point Pa”. The point Pa, however, is not calculated in the case where the candidate reward program is not available in the shop.

The appropriate reward program determination portion 103 calculates the number of reward points of each of such other reward programs in accordance with the amount of purchase this time. The number of reward points thus calculated is converted into (exchanged for) reward points of the candidate reward program. Hereinafter, the number of such reward points after the conversion is referred to as a “point Qa”, “point Qb”, “point Qc”, or the like.

The appropriate reward program determination portion 103 determines an appropriate reward program depending on the highest value from among the point Pa, the point Qa, the point Qb, the point Qc, and so on in the following manner (#156). If the point Pa has the highest value, then the appropriate reward program determination portion 103 determines that the candidate reward program is an appropriate reward program. If one of the points other than the point Pa has the highest value, then the appropriate reward program determination portion 103 determines that a reward program corresponding to the reward points having the highest value before the conversion is an appropriate reward program.

On the other hand, suppose that if the candidate reward program is not available in the shop, and at the same time, there are no other reward programs whose reward points can be exchanged for reward points of the candidate reward program (No in #154). In such a case, the appropriate reward program determination portion 103 sets a reward program providing an item having the next target order to be a candidate (#157, No in #158, and #152), and selects an appropriate reward program according to the method discussed above (#153 to #156).

If the appropriate reward program determination portion 103 cannot determine that even a reward program providing an item having the lowest target order is an appropriate reward program (Yes in #158), then the appropriate reward program determination portion 103 outputs a result indicating that the determination fails (#159).

Incidentally, the number of reward points held by a customer sometimes exceeds the number of reward points required to obtain a target item when all reward points corresponding to the amount of purchase are awarded as reward points of a single reward program. In such a case, it is possible to award the customer reward points only by the amount required to obtain the target item, and to award the customer the remaining reward points as reward points necessary to obtain items whose target orders are lower than that of the target item. In that case, the receipt as illustrated in FIG. 16 may be issued to the customer.

In the embodiments discussed above, the overall configuration of the terminal 1 and the items setting device 4, the configurations of various portions thereof, the content to be processed, the processing order, the configuration of the databases, and the like may be altered as required in accordance with the subject matter of the present invention.

This invention is suitably used in order to prompt consumers to make a purchase by improving the convenience of a reward program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention.

What is claimed is:

1. A method for supporting a member in selecting any one of a plurality of reward programs that award the member a reward point and allow the member to redeem reward points accumulated by the member for an item, the method comprising:
providing an item information storage section that stores item information, the item information indicating, on an item-by-item basis, a name of the item, a quantity of reward points required to be redeemed for the item, and a reward program awarding a reward point redeemable for the item;
presenting the item information to the member;
storing, in a selected item information storage section, on a member-by-member basis, selected item information indicating items selected by the member by giving priorities to the items thus selected;
obtaining, when a member is awarded a reward point in a shop, the selected item information of the member from the selected item information storage section;
determining that, among a plurality of reward programs that award a reward point redeemable for any of the items indicated in the selected item information thus obtained and are available in the shop, one of the plurality of reward programs is suitable for the member, said one of the plurality of reward programs awarding a reward point necessary to obtain an item placed in a highest priority order indicated in the selected item information; and
presenting, to the member, said one of the plurality of reward programs thus determined.

2. A method for supporting a member in selecting any one of a plurality of reward programs that award the member a reward point and allow the member to redeem reward points accumulated by the member for an item, the method comprising:
providing an item information storage section that stores item information, the item information indicating, on an item-by-item basis, a name of the item, a quantity of reward points required to be redeemed for the item, and a reward program awarding a reward point redeemable for the item;
presenting the item information to the member;
storing, in a selected item information storage section, on a member-by-member basis, selected item information indicating items selected by the member;
obtaining, when a member is awarded a reward point in a shop, the selected item information of the member from the selected item information storage section;
making a first determination of determining that, if a first reward program of a plurality of reward programs awarding a reward point redeemable for any of the items indicated in the selected item information is available in the shop, the first reward program is suitable for the member, and making a second determination of determining that, if the first reward program is not available in the shop, among a plurality of reward programs that award a reward point exchangeable for the reward point of the first reward program and are available in the shop, a second reward program awarding a largest quantity of reward points exchangeable for the reward point of the first reward program is suitable for the member; and
presenting, to the member, the first reward program determined as a result of the first determination, or, alternatively, the second reward program determined as a result of the second determination.

3. A method for supporting a member in selecting any one of a plurality of reward programs that award the member a reward point and allow the member to redeem reward points accumulated by the member for an item, the method comprising:
providing an item information storage section that stores item information, the item information indicating, on an item-by-item basis, a name of the item, a quantity of reward points required to be redeemed for the item, and a reward program awarding a reward point redeemable for the item;
presenting the item information to the member;
storing, in a selected item information storage section, on a member-by-member basis, selected item information indicating items selected by the member;
obtaining, when a member is awarded a reward point in a shop, the selected item information of the member from the selected item information storage section;
calculating a first point that indicates a quantity of reward points to be awarded this time to the member based on a first reward program that awards a reward point redeemable for any of the items indicated in the selected item information and is available in the shop;
calculating a second point that indicates a quantity of reward points to be awarded this time to the member based on a second reward program that awards a reward point exchangeable for a reward point redeemable for any of the items indicated in the selected item information and is available in the shop;
calculating a third point that indicates a quantity of reward points for a case where the reward point indicated in the second point is converted into a reward point of the first reward program that awards a reward point redeemable for any of the items indicated in the selected item information;
comparing the first point with the third point;
making a first determination of determining that, if the first point is larger than the third point, the first reward program that awards a reward point redeemable for any of the items indicated in the selected item information is suitable for the member, and making a second determination of determining that, if the third point is larger than the first point, the second reward program corresponding to a reward point from which the reward point of the third point is converted is suitable for the member; and
presenting, to the member, the first reward program determined as a result of the first determination, or, alternatively, the second reward program determined as a result of the second determination.

4. The method according to claim 1, wherein if a predetermined setting is performed by the member, the member is awarded a reward point of said one of the plurality of reward programs that has been determined to be suitable for the member irrespective of whether or not said one of the plurality of reward programs is presented to the member.

5. The method according to claim 1, wherein the selected item information storage section is a portable storage medium distributed on a member-by-member basis, and
the selected item information of the member is stored in the portable storage medium of the member.

6. A system for supporting a member in selecting any one of a plurality of reward programs that award the member a reward point and allow the member to redeem reward points accumulated by the member for an item, the system comprising:
an item information storage section that stores item information, the item information indicating, on an item-by-item basis, a name of the item, a quantity of reward points required to be redeemed for the item, and a reward program awarding a reward point redeemable for the item;
an item information presenting section that presents the item information to the member;
a selected item information registration processing section that causes a selected item information storage section to store selected item information, the selected item information indicating items selected by the member by giving priorities to the items thus selected;
a selected item information obtaining section that obtains, when a member is awarded a reward point in a shop, the selected item information of the member from the selected item information storage section;
an appropriate reward program determination section that determines that, among a plurality of reward programs that award a reward point redeemable for any of the items indicated in the selected item information thus obtained and are available in the shop, one of the plurality of reward programs is suitable for the member, said one of the plurality of reward programs awarding a reward point necessary to obtain an item placed in a highest priority order indicated in the selected item information; and
a reward program presenting section that presents, to the member, said one of the plurality of reward programs thus determined.

7. A system for supporting a member in selecting any one of a plurality of reward programs that award the member a reward point and allow the member to redeem reward points accumulated by the member for an item, the system comprising:
an item information storage section that stores item information, the item information indicating, on an item-by-item basis, a name of the item, a quantity of reward points required to be redeemed for the item, and a reward program awarding a reward point redeemable for the item;
an item information presenting section that presents the item information to the member;
a selected item information registration processing section that causes a selected item information storage section to store selected item information indicating items selected by the member;
a selected item information obtaining section that obtains, when a member is awarded a reward point in a shop, the selected item information of the member from the selected item information storage section;
an appropriate reward program determination section that makes a first determination of determining that, if a first reward program of a plurality of reward programs awarding a reward point redeemable for any of the items indicated in the selected item information thus obtained is available in the shop, the first reward program is suitable for the member, and makes a second determination of determining that, if the first reward program is not available in the shop, among a plurality of reward programs that award a reward point exchangeable for the reward point of the first reward program and are available in the shop, a second reward program awarding a largest quantity of reward points exchangeable for the reward point of the first reward program is suitable for the member; and
a reward program presenting section that presents, to the member, the first reward program determined as a result of the first determination, or, alternatively, the second reward program determined as a result of the second determination.

8. The system according to claim 6, further comprising a reward point allocation processing section that performs a process for awarding the member a reward point of said one of the plurality of reward programs that has been determined to be suitable for the member.

9. The system according to claim 6, wherein the reward program presenting section presents, to the member, along with said one of the plurality of reward programs that has been determined to be suitable for the member, information on a discount for a case where each of the plurality of reward programs is used.

10. The system according to claim 6, further comprising a reward point allocation processing section that performs a process for awarding the member a reward point of the reward program selected by the member.
